(19) United States
(12) Patent Application Publication
(10) Pub. No.: US 2016/0116890 A1
(43) Pub. Date: Apr. 28, 2016

(54) APPLIANCE CONTROL STRUCTURE

(71) Applicant: CHUN HUI LIN, Taipei (TW)

(72) Inventor: CHUN HUI LIN, Taipei (TW)

(21) Appl. No.: 14/522,675

(22) Filed: Oct. 24, 2014

(51) Int. Cl. G05B 15/02; H04L 12/28; G05B 23/02

(52) U.S. Cl. CPC G05B 15/02; G05B 23/0267; H04L 12/2825

(57) ABSTRACT

In the appliance control structure, an operation mechanism and a control mechanism may communicate with each other at a remote end so that an appliance apparatus may be controlled as being activated or shut down, the control mechanism may inform online the operation mechanism regarding a state of the appliance apparatus, and an external switch unit may be instead employed to serve as an operation and control source when the control mechanism is damged, so that the efficacies of effectively perceiving the operational state of the appliance apparatus and avoiding an energy waste issue.

### FIELD OF THE INVENTION

The present invention relates to an appliance control structure, and particularly to an appliance control structure where an operational state of the appliance appratus may be effectively percieved and an energy waste may be avoided.

### DESCRIPTION OF THE RELATED ART

Generally, a control apparatus for a home appliance is composed of a centeral control unit, a plurality of appliance units connected to the central control unit, and a mobile phone connected to the central control unit, so that a user may operate and control appliance units to be activated or shut down throguh the central control unit by using a mobile phone at a remote end.

Although the appliance control appratus may be operated and controled to be activated or shut down through the central control unit by using the mobile phone at the remote end, since th eappliance unit is only connected to the central control unit and thusthe central control unit is sued as a switch for the activation or shut-sown, the appliance units may not oeprate normally whenever the central control unit is failured or damaged, resulting in a troublesome in use. Further, the central control unit may only receive the signal form the mobile phone for activation or shut-down of the appliance units, but may not communicate with the mobile phone by itself, this causes the user may not perceive the condition of the appliance units. A common case is that a mis-contact of the appliance units may result in an energy waste.

### SUMMARY OF THE INVENTION

It is, therefore, an object of the present invention to provide an appliance control structure where an operation mechanism and a control mechanism may communicate with each other at a remote end so that an appliance apparatus may be controlled as being activated or shut down, the control mechanismm may inform online the operation mechanism regarding a state of the appliance apparatus, and an external switch unit may be instead employed to serve as an operation and control source when the control mechanism is damged, so that the efficacies of effectively perceiving the operational state of the appliance apparatus and avoiding an energy waste issue.

To achieve the above object, the appliance control structure according to the present invention comprises a control mechanism, comprising a processing unit, and a switch unit interface electrically connected to the processing unit; at least an appliance apparatus, conneccted electrically to the mechanism; a lamp control module, electrically connected to the control mechanism; a safety mechanism, electrically connected to the control mechanism; a video apparatus, electrically connected to the control mechanism; a timing control mechanism, electrically connected to the control mechanism; a detection mechanism, electrically connected to the control mechanism; a network mechanism, electrically connected to the control mechanism; at least an operation mechanism, connected to the control mechanism; an external switch unit, electrically connected to the switch unit interface of the control mechanism.

In an embodiment, the processing unit of the control mechanism is further electrically connected to an extension interface, a reset unit, a power input port, a fine motion switch, a mode change switch, a first communications, a second communicaitons interface, a third communicaitons interface, a first contact unit, a second contact unit, a third contact unit and a display unit.

In an embodiment, the extension interface comprises an output port and an input port.

In an embodiment, the first communcations interface is a RS-232 connector.

In an embodiment, the second communcations interface is a RS-485 connector.

In an embodiment, the third communcations interface is a RJ-45 connector.

In an embodiment, the display unit is one of a LED and a screen.

In an embodiment, the appliance apparatus is selected from a group consisting of an electric curtain, an electric fan, a television, and an air-conditioner.

In an embodiment, the timing control mechanism may generate a schedual sorting so that a use efficiency of any kind of the appliance apparatus and the lamp control module is improved and an energy saving effect is achieved.

In an embodiment, the detection mechanism is used to detect if any damage occurring on the lamp detection module.

In an embodiment, the video apparatus is a camera.

In an embodiment, the network mechanism comprises an apparatus network and the Internet.

In an embodiment, the operation mechanism is one of a smart mobile phone and a handheld or fixed Internet connectable device or remote controller, and the operation mechanism is wirelessly or wiredly connected to the control mechanism.

In an embodiment, the external switch unit is a press switch.

### BRIEF DESCIPTION OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention;

FIG. 2 is a schematic diagram of a control mechanism according to the present invention;

FIG. 3 is a schematic diagram of a use state according to the present invention; and

FIG. 4 is a schematic diagram of a muti-switch state according to the present invention;

FIG. 5 is a schematic diagram of another embodiment according to the present invention; and

FIG. 6 is a schematic diagram of yetanother embodiment according to the present invention.

### DESCRIPTION OF THE PREFERRED EMBODIMENTS

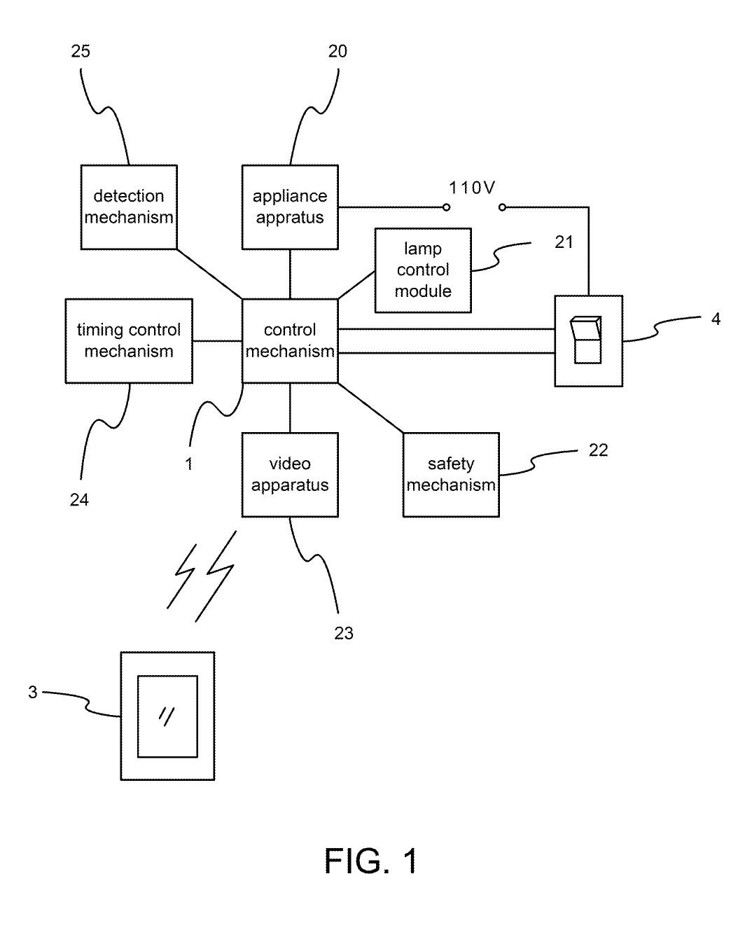

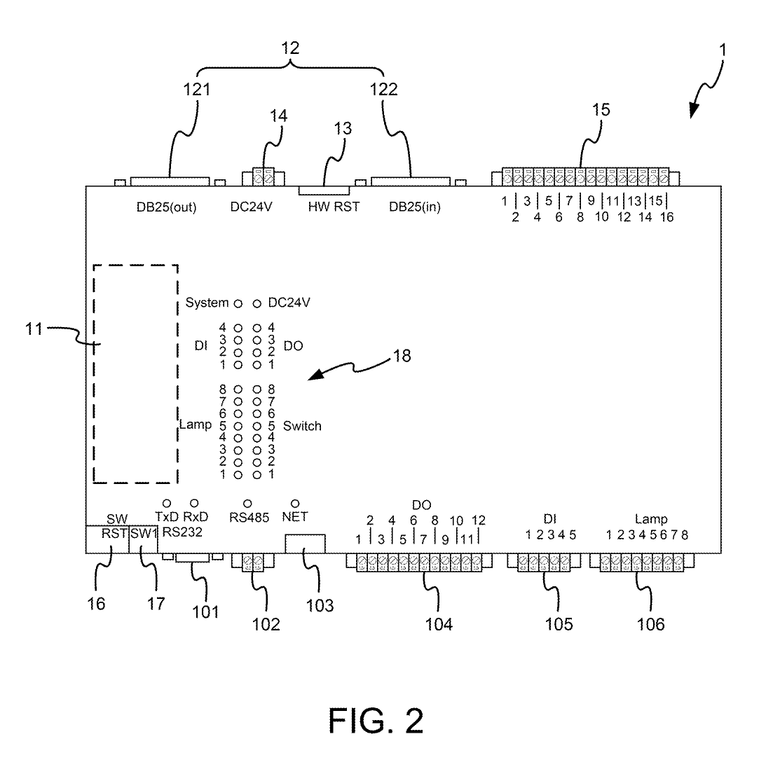

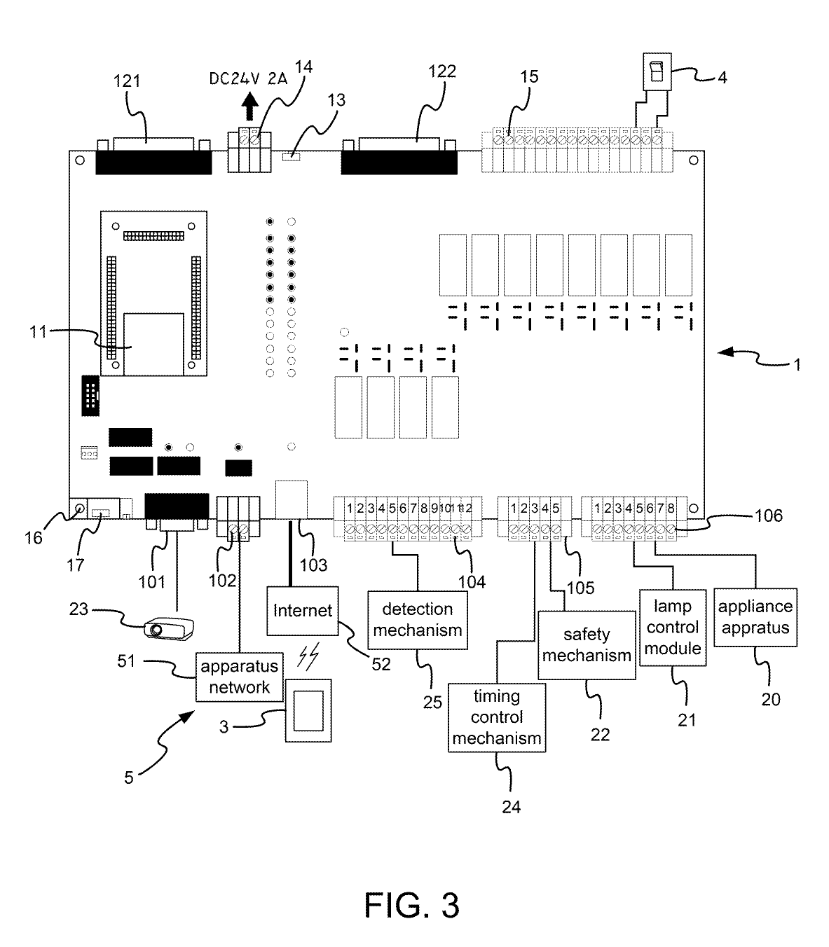

Referring to FIG. 1, FIG. 2, and FIG. 3, FIG. 1, a schematic diagram of a basic architecture according to the present invention, a schematic diagram of a control mechanism according to the present invention, a schematic diagram of a use state according to the present invention, are shown therein. As shown, the appliance ocntrol structure comprises a control mechanism 1, at least an appliance apparatus 20, a lamp control module 21, a safety mechanism 22, a video apparatus 23, a timing control mechanism 24, detection mechanism 25, a network mechanism, at least an operation mechanism 3 and an external switch unit 4.

The mentioned control mechanism 1 at least comprises a processing unit 11, and an extension unit 12, a reset unit 13, a power input port 14, a switch unit interface 15, a fine motion switch 16, a mode change switch 17, a first communications interface 101, a second communications 102, a third communications interface 101, a second communicaitons 102, a third communications interace 103, a first contact unit, a second contact unit 105, a third contact unit 106, and a display unit 18, which are electrically connected to the processing unit 11, respectively.

The extension interface 12 comprises an output port 121 and an input port 122. The first communcations interface is a RS-232 connector, the second communcations interface is a RS-485 connector, and the third communcations interface is a RJ-45 connector.

The display unit 18 is one of a LED and a screen, and the LED is taken in the recited embodiment.

Each of the appliance apparatuses 20 is electrically connected to the control mechanism 1, and may be an electric curtain, an electric fan, a television, and an air-conditioner.

The lamp control module 21 is electically connected to the control mechanism 1, and connected to lamps in the room (not shown).

The safety mechanism 22 is electrically connected to the control mechanism 1, and connected to a door lock and a fuel gas valve (not shown).

The video apparatus 23 is a camera and electrically connected to the control mechanism 1.

The timing control mechanism 24 is electrically connected to the control mechanism 1 and may generate a schedual sorting so that a use efficiency of any kind of the appliance apparatuses 20 and the lamp control module 21 is improved and an energy saving effect is achieved.

The detection mechanism 25 is electrically connected to the control mechanism 1 and used to detect if any damage occurring on the lamp detection module.

The network mechanism 5 comprises an apparatus network 51 and the Internet 52.

The operation mechanism 3 is one of a smart mobile phone and a handheld or fixed Internet connectable device or remote controller, and the operation mechanism 3 is wirelessly or wiredly connected to the control mechanism 1.

The external switch unit 4 is a press switch and electrically connected to the switch unit interface 15 of the control mechanism 1, a wireless connection manner is taken in the embodiment, and a press switch. As such, the above structure consitute a novel appliance ocntrol structure.

When the present invnetion is operated, the power input port 14 is connected to a 24V DC input voltage. At the first, second, and third communications interfaces 101, 102, 103, the video apparatus 23, the apparatus network 51, and the Internet 52 are connected, respectively. And, at the first, second, adn third contact units 104, 105, 106 of the control mechanism 1, the appliance appratuses 20, the lamp control module 21, safety mechanism 22, the timing control mechanism 24, and the deteciton mechanism 25. Each of the appliance apparatuses 20, the lamp control module 21, safety mechanism 22, the timing control mechanism 24, the detection mechanism 25 are connected to an 110V DC commerical power. However, the above description is merely an embodiment, the actual connection among appratuses depends on the actual conditions.

In use, the operation mechanism 3 is connected to the Internet 52 at a remote end, and inputed for activation or shut-down of appliance apparatus 20, the lamp control module 21, and the safety mechanism 22, the timing control mechanism 24, and the detection mechanism 25. After the processing unit 11 receives a command from the operation mechanism 3, it controls the appliance apparatus 20, the lamp module 21, and the safety mechanism 22, the timing control mechanism 24, and the detection mechanism 25 to be activated or shut-down, through the first, second, third contact units 104, 105, 106. In addition, the video appratus 23 is used to acquire associated images of the appliance apparatus 20, the lamp control module 21, and the safety mechanism 22, the timing control mechanism 24, and the deteciton mechanism 25. The images are transmitted to the operaiton mechanism 3 through the Internet 52, so that the operation mechanism 3 is informed with states of the appliance apparatus 20, the lamp control module 21, and the safety mechanism 22, the timing control mechanism 24, and the deteciton mechanism 25.

When operating simultaneously with the control mechanism 1, the operational states of the operation mechanism 3 is displayed with different lamp indications. When the control mechanism 1 has a damge on the first, second, or third contact units 104, 105, 106, a user may employ the external switch unit 4 to directly operate and control the appliance appratuses 20, the lamp module 21, the safety mechanism 22, the itming control mechanism 24, and the detection mechanism 25. Further, the reset unit 13 enables the control mechanism 1 to reset and exclude the failure. As such, the oepraitonal states may be effectively perceived and an energy waste may be avoided.

However, the abovedescription is merely an embodiment of the present invention, the actual use depends on the actual requirements with respect to the jointly used appliance kinds. And, the switch unit interface 15 of the control mechanism 1 may be further electrically connected to another external switch unit 4, so that the present invnetion may be applied onto a doule switch mode, lending itself to have more applications.

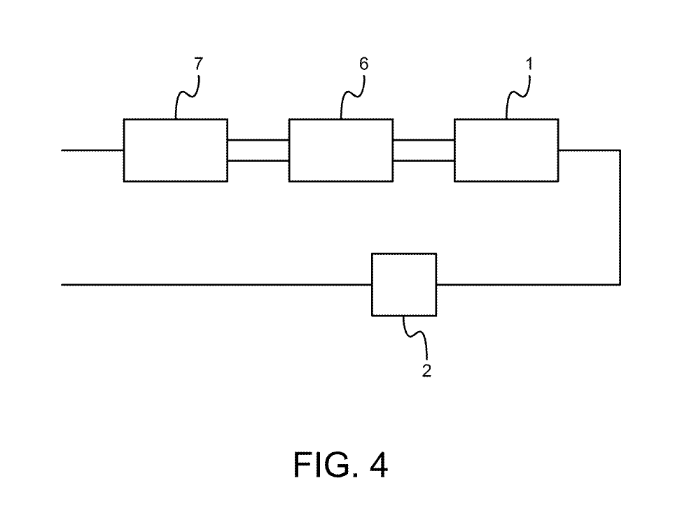

Referring to FIG. 4, a schematic diagram of a muti-switch state according to the present invention is shown therein. As shown, the control mehcanism 1 may be further connected with a four-way switch 6, and the four-way switch may be further connected with a three-way switch 7, in addition to the above embodiment. In this manner, a multi-switch mode is provided, lending the present invention to be more satisfactory to the user.

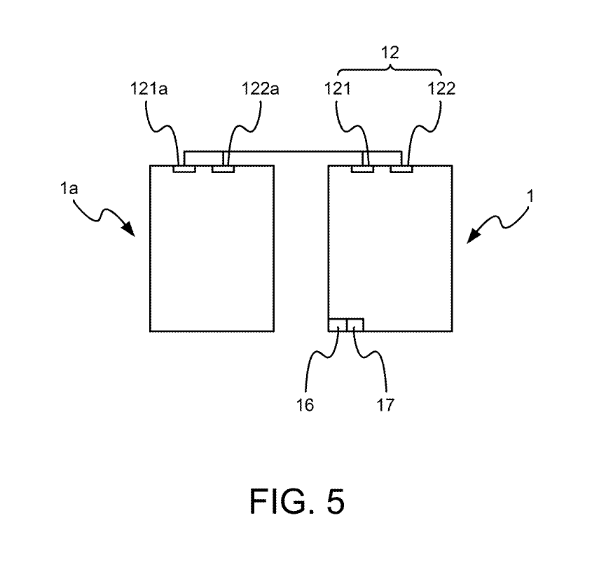

Referring to FIG. 5, a schematic diagram of another embodiment according to the present invention is shown therein. As shown, the control mechanism 1 may be further connected to an output port 121a and input port 122a of other control mechanism 1a at its extension interface 12 as an extension policy. And, the fine motion switch 16 and mode switch switch 17 are used to facilitate the switching, operating, and controlling actions.

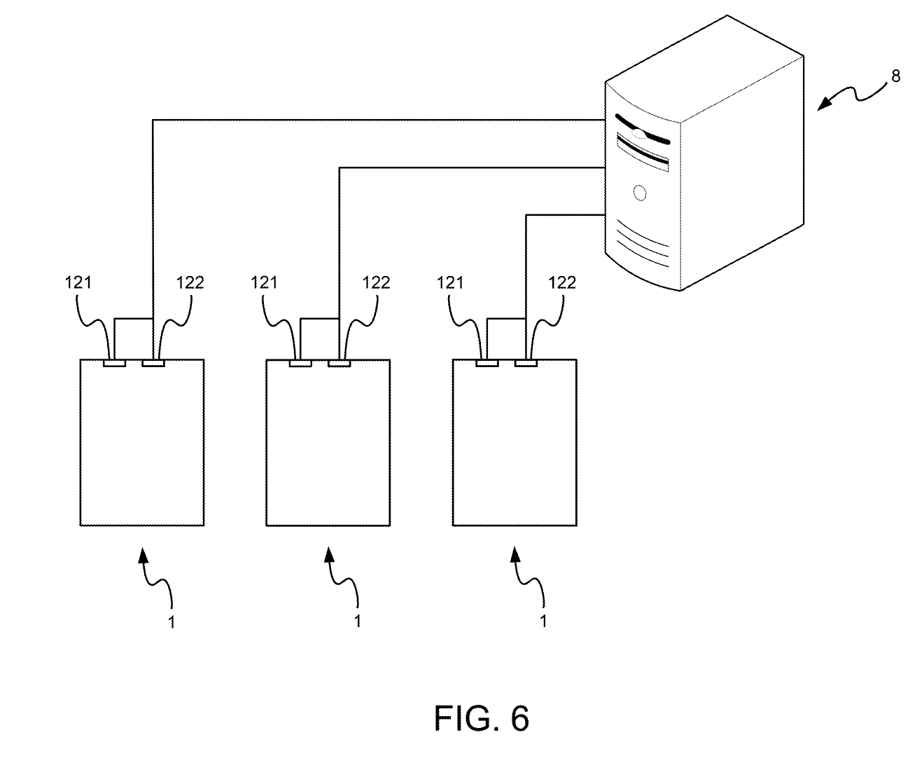

Referring to FIG. 6, a schematic diagram of yet another embodiment according to the present invention is shown therein.

In addition to the above embodiment, the output ports 121 and input ports 122 of a multiple of control mechanisms 1 may be connected to a server 8 which may be installed at a building control center, so that the multiple of control mechanism 1 may be controlled and managed. In this manner, the present invention may be more satisfactory to the user for the actual use case.

In view of the above, the appliance control structure may effectively improve the demerits in the prior art, where the operation mechanism and the control mechanism may communicate with each other at a remote end so that the appliance apparatus may be controlled as being activated or shut down, the control mechanism may inform online the operation mechanism regarding a state of the appliance apparatus, and the external switch unit may be instead employed to serve as an operation and control source when the control mechanism is damged, so that the efficacies of effectively perceiving the operational state of the appliance apparatus and avoiding an energy waste issue.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

1. An appliance control structure, comprising:
a control mechanism, comprising a processing unit and a switch unit interface electrically connected to the processing unit;
at least an appliance apparatus, conneccted electrically to the mechanism;
a lamp control module, electrically connected to the control mechanism;
a safety mechanism, electrically connected to the control mechanism;
a video apparatus, electrically connected to the control mechanism;
a timing control mechanism, electrically connected to the control mechanism;
a detection mechanism, electrically connected to the control mechanism;
a network mechanism, electrically connected to the control mechanism;
at least an operation mechanism, connected to the control mechanism;
an external switch unit, electrically connected to the switch unit interface of the control mechanism.

2. The appliance control structure as claimed in claim 1, wherein the processing unit of the control mechanism is further electrically connected to an extension interface, a reset unit, a power input port, a fine motion switch, a mode change switch, a first communications, a second communicaitons interface, a third communicaitons interface, a first contact uit, a second contact unit, a third contact unit and a display unit.

3. The appliance control structure as claimed in claim 2, wherein the extension interface comprises an output port and an input port.

4. The appliance control structure as claimed in claim 2, wherein the first communcations interface is a RS-232 connector.

5. The appliance control structure as claimed in claim 2, wherein the second communcations interface is a RS-485 connector.

6. The appliance control structure as claimed in claim 2, wherein the third communcations interface is a RJ-45 connector.

7. The appliance control structure as claimed in claim 2, wherein the display unit is one of a LED and a screen.

8. The appliance control structure as claimed in claim 1, wherein the appliance apparatus is selected from a group consisting of an electric curtain, an electric fan, a television, and an air-conditioner.

9. The appliance control structure as claimed in claim 1, wherein the timing control mechanism may generate a schedual sorting so that a use efficiency of any kind of the appliance apparatus and the lamp control module is improved and an energy saving effect is achieved.

9. The appliance control structure as claimed in claim 1, wherein the detection mechanism is used to detect if any damage occurring on the lamp detection module.

10. The appliance control structure as claimed in claim 1, wherein the video apparatus is a camera.

11. The appliance control structure as claimed in claim 1, wherein the network mechanism comprises an apparatus network and the Internet.

12. The appliance control structure as claimed in claim 1, wherein the operation mechanism is one of a smart mobile phone and a handheld or fixed Internet connectable device or remote controller, and the operation mechanism is wirelessly or wiredly connected to the control mechanism.

13. The appliance control structure as claimed in claim 1, wherein the external switch unit is a press switch.
